(19) United States
(12) Patent Application Publication
(10) Pub. No.: US 2010/0169323 A1
(43) Pub. Date: Jul. 1, 2010

(54) Query-Dependent Ranking Using K-Nearest Neighbor

(75) Inventors: Tie-Yan Liu, Beiing (CN); Xiubo Geng, Beijing (CN); Hang Li, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/344,607

(22) Filed: Dec. 29, 2008

(51) Int. Cl. G06F 17/30; G06F 7/00

(52) U.S. Cl. 707/748; 707/E17.008; 707/E17.017

(57) ABSTRACT

Described is a technology in which documents associated with a query are ranked by a ranking model that depends on the query. When a query is processed, a ranking model for the query is selected/determined based upon nearest neighbors to the query in query feature space. In one aspect, the ranking model is trained online, based on a training set obtained from a number of nearest neighbors to the query. In an alternative aspect, ranking models are trained offline using training sets; the query is used to find a most similar training set based on nearest neighbors of the query, with the ranking model that corresponds to the most similar training set being selected for ranking. In another alternative aspect, the ranking models are trained offline, with the nearest neighbor to the query determined and used to select its associated ranking model.

### BACKGROUND

Contemporary search engines are based on information retrieval technology, which finds and ranks relevant documents for a query, and then returns a ranked list. Many ranking models have been proposed in information retrieval; recently machine learning techniques have also been applied to constructing ranking models. However, existing methods do not take into consideration the fact that significant differences exist between types of queries.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a query is processed, including to find documents for the query. The documents are ranked using a ranking model for the query that is selected/determined based upon the query. In one aspect, nearest neighbor concepts (of the query in query feature space) are used to determine/select the ranking model.

In one aspect, selection/determination of the ranking model is performed by training the ranking model online, based on a training set obtained from a number of nearest neighbors to the query. In an alternative aspect, selection/determination of the ranking model includes training a plurality of ranking models offline with a corresponding plurality of training sets, finding a most similar training set based on nearest neighbors of the query, and selecting as the ranking model the model that corresponds to the most similar training set. In another alternative aspect, selection/determination of the ranking model includes training a plurality of ranking models offline with a corresponding plurality of training sets, finding a nearest neighbor to the query, and selecting the ranking model that is associated with the training set that corresponds to the nearest neighbor of the query.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components for query dependent ranking.

FIG. 2 is a representation of selecting a ranking model based on online training of the ranking model using k-nearest neighbors corresponding to query features of a training set.

FIG. 3 is a flow diagram showing example steps for online training of the query-dependent ranking model.

FIG. 4 is a representation of selecting a ranking model based on offline training of ranking models using k-nearest neighbors to determine a most similar training set.

FIGS. 5 and 6 comprise a flow diagram showing example steps of offline training of ranking models and selecting a ranking model using k-nearest neighbors to determine a most similar training set.

FIG. 7 is a representation of selecting a ranking model based on offline training of ranking models, and finding a nearest neighbor to select its corresponding ranking model.

FIG. 8 comprises a flow diagram (e.g., when combined with FIG. 5) showing example steps of offline training of ranking models and finding a nearest neighbor to select its corresponding ranking model.

FIG. 9 shows an illustrative example of a computing environment into which various aspects of the present invention may be incorporated.

### DETAILED DESCRIPTION

Various aspects of the technology described herein are generally directed towards employing different ranking models for different queries, which is referred to herein as “query-dependent ranking.” In one implementation, query-dependent ranking is based upon a K-Nearest Neighbor (KNN) method. In one implementation, an online method creates a ranking model for a given query by using the labeled neighbors of the query in query feature space, with the retrieved documents for the query then ranked by using the created model. Alternatively, offline approximations of KNN-based query-dependent ranking are used, which creates the ranking models in advance to enhance the efficiency of ranking.

It should be understood that any of the examples described herein are non-limiting examples. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and query processing in general.

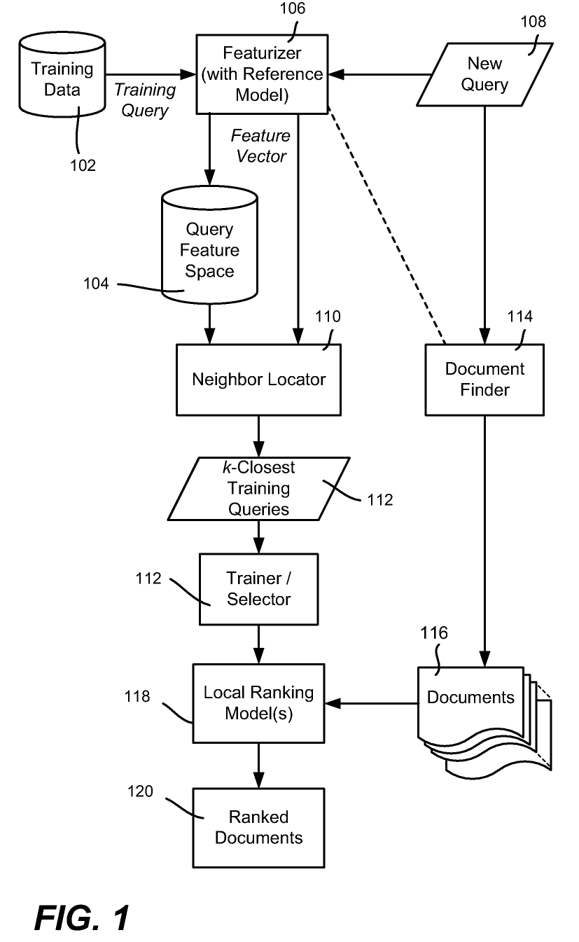

FIG. 1 shows aspects related to a query-dependent ranking function, including a KNN-based solution as described herein. In general, FIG. 1 represents the online model training and usage as well as the offline models, each of which are described below.

In general, training queries from a set of training data 102 are featurized in a known manner into a query feature space 104, as represented by the featurizer block 106. In other words, for each training query qᵢ (with corresponding training data as S_{q}_{ᵢ}i, 1, . . . ,m) a feature vector is defined and represented in the query feature space 104 (a Euclidean space).

When a new query 108 is processed, its features are similarly extracted (e.g., by the featurizer block 106) and used to locate one or more of its nearest neighbors, as represented by the block 110. As is readily understood, the query features that are used determine the accuracy of the process. While many ways to derive query features are feasible, one implementation used a heuristic method to derive query features, namely, for each query q, a reference model (e.g., BM25) is used to find its top T documents; note that the featurizer block 106 is also shown as incorporating the reference model. Once these are found, the process takes a mean of the feature values of the T documents as a feature of the query. For example, if a feature of the document is tf-idf, (term frequency-inverse document frequency) then the corresponding query feature becomes the average tf-idf of the top T documents of the query. If there are many relevant documents, then it is very likely that the value of the average tf-idf is high.

To locate the nearest neighbors, given the new query 108, the k closest training queries to it in terms of Euclidean distance in feature space are found, as represented via block 112. The new query is also processed (e.g., as represented by block 114) to find relevant documents 116, which are unranked.

Unlike conventional ranking mechanisms that simply rank the documents, a local ranking model 118 is selected that depends on the query. In the online version, the local ranking model 118 is trained online using the neighboring training queries 112 (denoted as Nₖ(q)). In the offline versions, the local ranking models are trained in advance, with nearest neighbor concepts applied in selecting a local ranking model, e.g., based on a most similar training set, or based on the local ranking model associated with a nearest neighbor.

Once trained and/or selected, the documents 116 of the new query are then ranked using the trained local model 118, as represented by the ranked documents 120, which are returned in response to the query. As can be seen, in any alternative the overall process employs a k-nearest neighbor-based method for query dependent ranking.

For training the local ranking model 118, any existing stable learning to rank algorithm may be used. One such algorithm that was implemented is Ranking SVM. Note that S_{q}_{ᵢ} contains query qᵢ, the training instances derived from its associated documents and the relevance judgments. When Ranking SVM is used as the learning algorithm, S_{q}_{ᵢ} contains all the document pairs associated with the training query qᵢ.

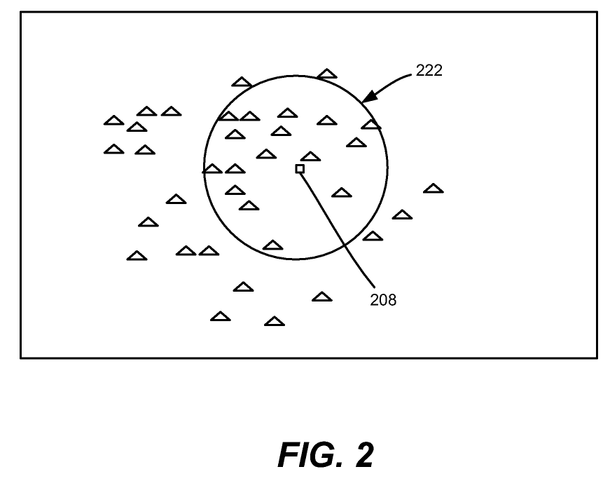

The online training process is referred to as “KNN Online”. FIG. 2 illustrates the working of the process, where the square 208 is a visual representation denoting the new query 108 (also referred to as q), each triangle denotes a training query, and the large circle 222 denotes the neighborhood of the query 108 based upon distance comparisons.

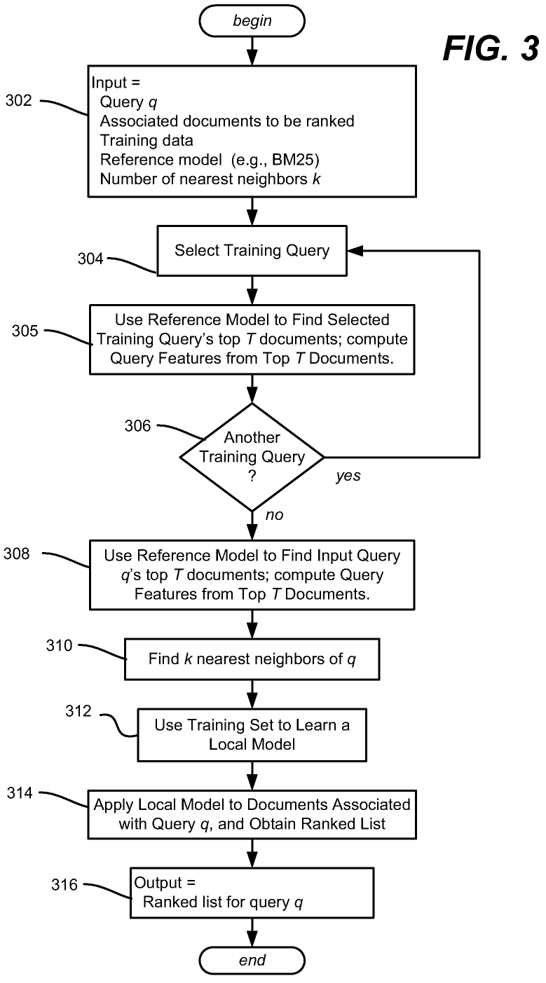

Example steps of a suitable KNN online algorithm are presented in the flow diagram of FIG. 3, beginning at step 302 where the algorithm takes as its input a new query q and the associated documents to be ranked. Also input in this example is the training data {S_{q}_{ᵢ},i=1, . . . ,m}, the reference model hᵣ (currently BM25) and the number of nearest neighbors k to find.

As mentioned above, part of the online algorithm is able to use some offline pre-processing as represented by steps 304-306, namely for each training query qᵢ, the reference model hᵣ is used to find its top T documents, and its query features computed from the documents.

The online training and using of the local model is represented beginning at step 308, where the reference model hᵣ is again used to find the top T documents, this time for the input query q, in order to compute its query features. Step 310 finds the k nearest neighbors of q, denoted as Nₖ(q) in the training data in the query feature space.

Given the nearest neighbors, at step 312 the training set

$${S}_{{N}_{k} ( q )} {=}^{Δ} {U}_{{q}^{′} ∈ {N}_{k} ( q )} {S}_{q}$$

is used to learn a local model h_{q}, Step 314 applies h_{q} to the documents associated with the query q, and obtains the ranked list. Step 316 represents the output of the ranked list for the query q.

As can be readily appreciated, the time complexity of the KNN Online algorithm is relatively high, with most of the computation time resulting from online model training and finding the k nearest neighbors. Model training is time consuming; for example, the time complexity of training a Ranking SVM model is of polynomial order in number of document pairs. When finding k nearest neighbors in the query feature space, using a straightforward search algorithm, the time complexity is of order 0(m log m), where m is the number of training queries.

To reduce the aforementioned time complexity, two alternative algorithms are described herein, which in general move the time-consuming steps to offline. These alternative algorithms are referred to KNN Offline-1 and KNN Offline-2.

KNN Offline-1 moves the model training step to offline. In general, for each training query qᵢ, its k nearest neighbors Nₖ (qᵢ) are found in the query feature space. Then, a model h_{q}_{ᵢ} is trained from S_{N}_{ₖ}_{(q}_{ᵢ}₎, offline and in advance.

When testing, for a new query q, its k nearest neighbors Nₖ(q) are also found. Then, the algorithm compares S_{N}_{ₖ}_{(q)} with every S_{N}_{ₖ}_{(q}_{ᵢ}₎,i=1, . . . ,m so as to find the one sharing the largest number of instances with S_{N}_{ₖ}_{(q)}.

$${S}_{{N}_{k} ( {q}_{i *} )} = arg {max}_{{S}_{{N}_{k} ( {q}_{i} )}} \vert {S}_{{N}_{k} ( {q}_{i} )} ⋂ {S}_{{N}_{k} ( q )} \vert , \qquad ( 1 )$$

where |.| denotes the number of instances in a set.
Next, the model of the selected training set h_{q}_{ᵢ}* (it has been created offline and in advance) is used to rank the documents of query q.

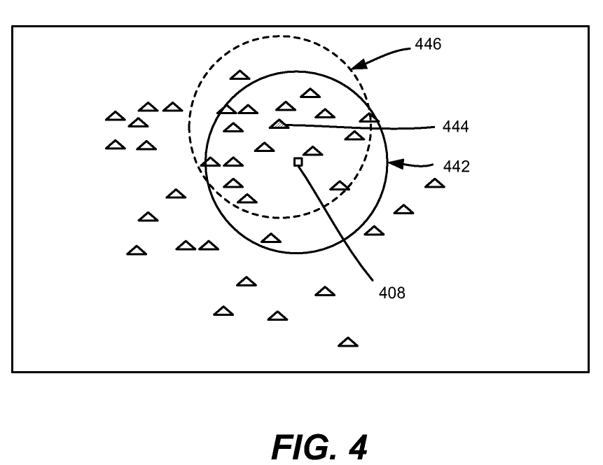

FIG. 4 illustrates the working of the KNN Offline-1 process, where the square 408 is a visual representation denoting the new query 108 (also referred to as q), and each triangle denotes a training query. The triangles in the solid-line circle 442 are the nearest neighbors of q, the shaded triangle 444 represents the selected training query qᵢ*, and the triangles in the dotted-line circle 446 are the nearest neighbors of qᵢ*. The model learned from the triangles in the dotted-line circle 446 is used to process the documents found for query q. Note that the model used in KNN Online and the model used in KNN Offline-1 are similar to each other, in terms of difference in loss of prediction.

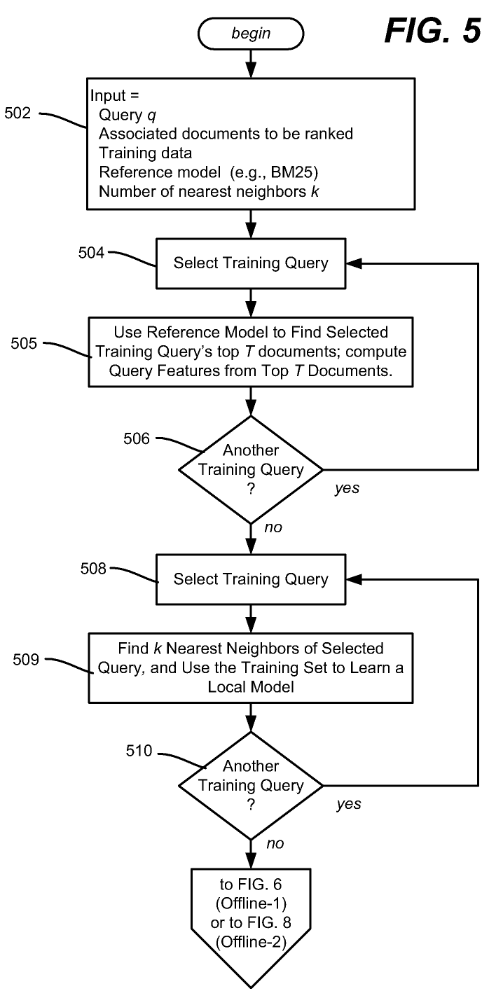

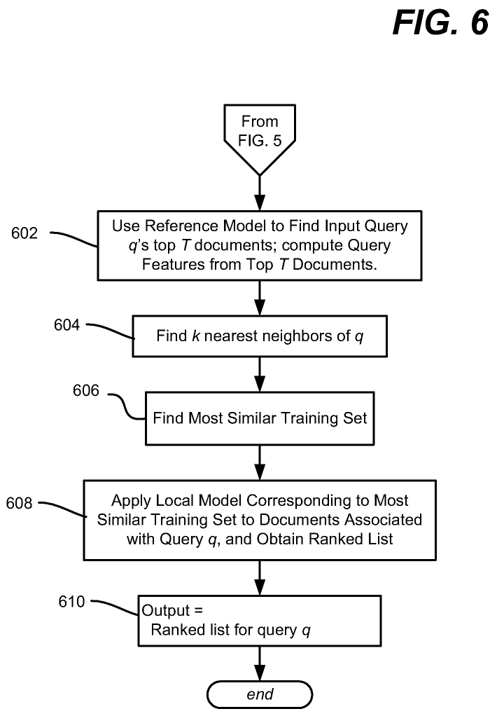

FIGS. 5 and 6 show example steps of a suitable KNN Offline-1 algorithm, beginning at step 502 where the algorithm takes as its input a test query q and the associated documents to be ranked. Also input is the training data {S_{q}_{ᵢ},i=1, . . . ,m}, the reference model hᵣ (currently BM25) and the number of nearest neighbors k to find. Similar to the offline portion of the online algorithm, offline pre-processing, as represented by steps 504-506, takes each training query qᵢ, uses the reference model hᵣ to find that training query's top T documents, and computes its query features from the documents.

Unlike the online algorithm, steps 508-510 are used to learn a local model offline. To this end, for each training query qᵢ, step 509 finds the k nearest neighbors of qᵢ, denoted as Nₖ(qᵢ) in the training data in the query feature space, and uses the training set S_{N}_{ₖ}_{(q}_{ᵢ}₎ to learn a local model h_{q}_{ᵢ}.

The online operation of the Offline-1 algorithm is exemplified in FIG. 6, beginning at step 602 where given the new query q, the reference model hᵣ is used to find top T documents of the query q, and compute its query features. Step 604 finds the k nearest neighbors of q, denoted as Nₖ(q), in the training data in the query feature space.

Then, step 606 finds the most similar training set S_{N}_{ₖ}_{(q}_{ᵢ}*₎ by using equation (1). At step 608, the training model for that training set, h_{q}_{ᵢ}*, is then applied to the documents associated with query q to obtain the ranked list. Step 610 outputs the ranked list for query q.

The KNN Offline-1 algorithm avoids online training, however, it introduces additional computation when searching the most similar training set. Also, it still needs to find the k nearest neighbors of the test query online, which is also time-consuming. As online response time is a significant consideration for search engines, yet another alternative algorithm, referred to as KNN Offline-2, may be used to further reduce the time complexity.

A general idea in the KNN Offline-2 is that instead of searching the k nearest neighbors for the test query q, only its nearest neighbor in the query feature space is found. For example, if the nearest neighbor is qᵢ*, only the model h_{q}_{ᵢ}* trained from S_{N}_{ₖ}_{(q}_{ᵢ}*₎ (offline and in advance) is applied to the new query q. In this way, the search of k nearest neighbors is simplified to that of the nearest neighbor, whereby Equation (1) to find the most similar training set need not be performed, thereby significantly reducing the time complexity.

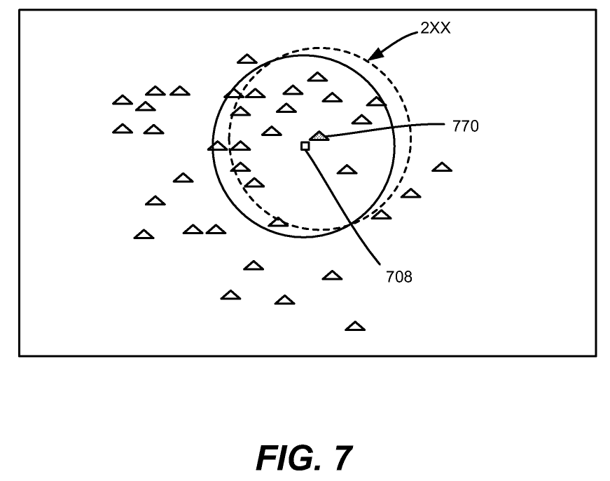

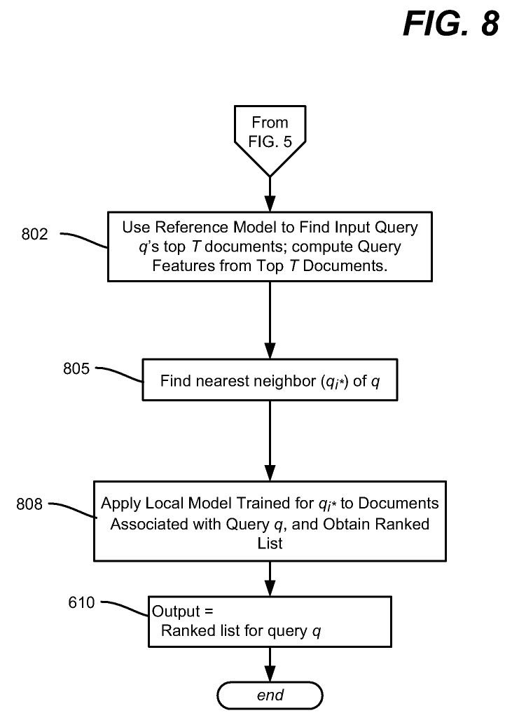

FIG. 7 illustrates the working of the KNN Offline-2 process, where the square 708 is a visual representation denoting the new query 108 (also referred to as q), and each triangle denotes a training query. The shaded triangle 770 is the nearest neighbor of q, that is, qᵢ*. While FIGS. 5 and 8 describe the KNN Offline-2 algorithm, for brevity it is noted that most of the steps are the same as in the KNN Offline-1 process, except that the steps 604 and 606 of the Offline-1 algorithm are replaced with step 805 in the Offline-2 algorithm, that is, “find the nearest neighbor of q, denoted as qᵢ*”.

### Exemplary Operating Environment

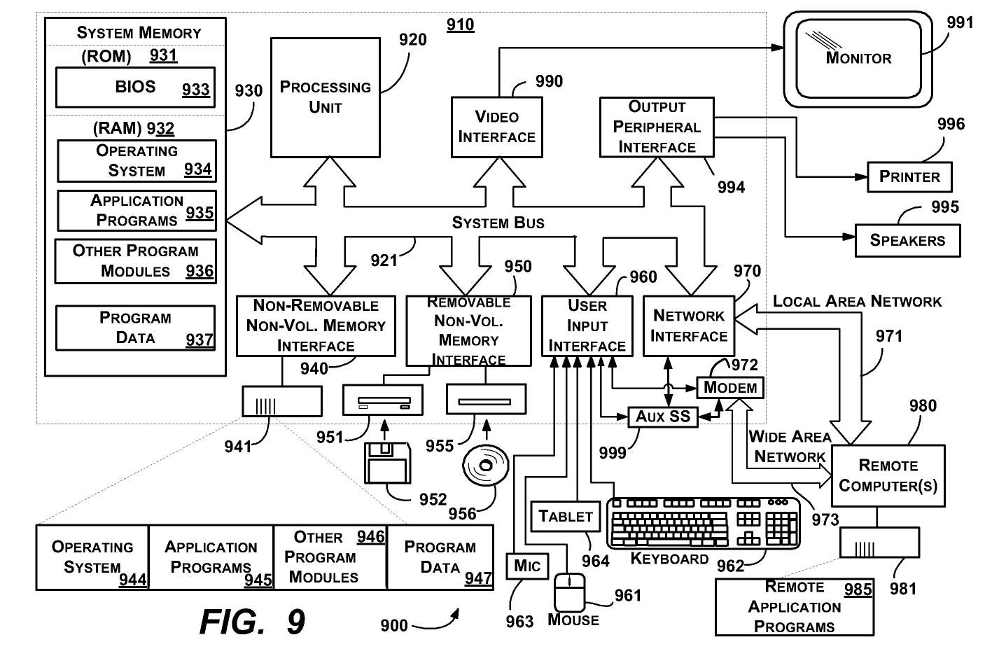

FIG. 9 illustrates an example of a suitable computing and networking environment 900 on which the examples of FIGS. 1-8 may be implemented. The computing system environment 900 is only one example of a suitable computing environment and is not intended to suggest any limitation as to the scope of use or functionality of the invention. Neither should the computing environment 900 be interpreted as having any dependency or requirement relating to any one or combination of components illustrated in the exemplary operating environment 900.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 9, an exemplary system for implementing various aspects of the invention may include a general purpose computing device in the form of a computer 910. Components of the computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 910 typically includes a variety of computer-readable media. Computer-readable media can be any available media that can be accessed by the computer 910 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 910. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936 and program data 937.

The computer 910 may also include other removable/non-removable, volatile/nonvolatile computer storage media. By way of example only, FIG. 9 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media, described above and illustrated in FIG. 9, provide storage of computer-readable instructions, data structures, program modules and other data for the computer 910. In FIG. 9, for example, hard disk drive 941 is illustrated as storing operating system 944, application programs 945, other program modules 946 and program data 947. Note that these components can either be the same as or different from operating system 934, application programs 935, other program modules 936, and program data 937. Operating system 944, application programs 945, other program modules 946, and program data 947 are given different numbers herein to illustrate that, at a minimum, they are different copies. A user may enter commands and information into the computer 910 through input devices such as a tablet, or electronic digitizer, 964, a microphone 963, a keyboard 962 and pointing device 961, commonly referred to as mouse, trackball or touch pad. Other input devices not shown in FIG. 9 may include a joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. The monitor 991 may also be integrated with a touch-screen panel or the like. Note that the monitor and/or touch screen panel can be physically coupled to a housing in which the computing device 910 is incorporated, such as in a tablet-type personal computer. In addition, computers such as the computing device 910 may also include other peripheral output devices such as speakers 995 and printer 996, which may be connected through an output peripheral interface 994 or the like.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include one or more local area networks (LAN) 971 and one or more wide area networks (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960 or other appropriate mechanism. A wireless networking component 974 such as comprising an interface and antenna may be coupled through a suitable device such as an access point or peer computer to a WAN or LAN. In a networked environment, program modules depicted relative to the computer 910, or portions thereof, may be stored in the remote memory storage device. By way of example, and not limitation, FIG. 9 illustrates remote application programs 985 as residing on memory device 981. It may be appreciated that the network connections shown are exemplary and other means of establishing a communications link between the computers may be used.

An auxiliary subsystem 999 (e.g., for auxiliary display of content) may be connected via the user interface 960 to allow data such as program content, system status and event notifications to be provided to the user, even if the main portions of the computer system are in a low power state. The auxiliary subsystem 999 may be connected to the modem 972 and/or network interface 970 to allow communication between these systems while the main processing unit 920 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a method comprising, processing a query, including finding documents for the query, determining a ranking model for the query that is dependent on the query, and using the ranking model to rank the documents.

2. The method of claim 1 wherein determining a ranking model for the query comprises training the ranking model with a learning to rank algorithm.

3. The method of claim 1 wherein determining the ranking model comprises determining at least one nearest neighbor in feature space corresponding to at least one feature of the query.

4. The method of claim 3 wherein determining a ranking model for the query comprises training a ranking model online based on a training set obtained from a number of nearest neighbors to the query.

5. The method of claim 3 wherein determining a ranking model for the query comprises training a plurality of ranking models offline with a corresponding plurality of training sets, finding a most similar training set based on nearest neighbors of the query, and selecting as the ranking model the model that corresponds to the most similar training set.

6. The method of claim 3 wherein determining a ranking model for the query comprises training a plurality of ranking models offline with a corresponding plurality of training sets, finding a nearest neighbor to the query, and selecting as the ranking model the model that is associated with a training set corresponding to a nearest neighbor of the query.

7. The method of claim 3 further comprising finding the at least one feature of the query, including finding a top number of documents associated with the query, and extracting at least one feature from the top number of the documents.

8. The method of claim 7 wherein one feature of the query comprises a mean of the feature values of the top number of documents.

9. In a computing environment, a system comprising, a featurizer that extracts features of a new query, and a selection mechanism that selects a ranking model for the new query that is dependent on the query, the ranking model used to rank documents associated with the query.

10. The system of claim 9 further comprising a trainer that trains the ranking model from training queries using a learning to rank algorithm.

11. The system of claim 9 wherein the featurizer is coupled to a reference model that finds a top number of documents associated with the new query, and extracts features from the top number of documents.

12. The system of claim 11 wherein the reference model comprises a BM25-based mechanism.

13. The system of claim 9 wherein the selection mechanism is coupled to an online training mechanism that trains the ranking model online based on a training set obtained from a number of nearest neighbors to the query.

14. The system of claim 9 wherein the selection mechanism is coupled to an offline training mechanism that trains a plurality of ranking models offline with a corresponding plurality of training sets, the selection mechanism finding a most similar training set based on nearest neighbors of the query, and selecting the ranking model based upon the most similar training set.

15. The system of claim 9 wherein the selection mechanism is coupled to an offline training mechanism that trains a plurality of ranking models offline with a corresponding plurality of training sets, the selection mechanism finding a nearest neighbor to the query, and selecting the ranking model based upon the nearest neighbor of the query.

16. One or more computer-readable media having computer-executable instructions, which when executed perform steps, comprising, processing a query, including finding documents for the query, selecting a ranking model for the query that is dependent on the query, including by finding at least one nearest neighbor of the query in query feature space, and using the ranking model to rank the documents.

17. The one or more computer-readable media of claim 16 wherein selecting the ranking model comprises training a ranking model online based on a training set obtained from a number of nearest neighbors to the query.

18. The one or more computer-readable media of claim 16 wherein selecting the ranking model comprises training a plurality of ranking models offline with a corresponding plurality of training sets, finding a most similar training set based on nearest neighbors of the query, and selecting as the ranking model the model that corresponds to the most similar training set.

19. The one or more computer-readable media of claim 16 wherein selecting the ranking model comprises training a plurality of ranking models offline with a corresponding plurality of training sets, finding a nearest neighbor to the query, and selecting as the ranking model the model that is associated with a training set corresponding to a nearest neighbor of the query.

20. The one or more computer-readable media of claim 16 having further computer-executable instructions comprising featurizing the query, including by finding a top number of documents associated with the query, and extracts featuring for the query based upon information in the top number of documents.
